(19) United States
(12) Patent Application Publication
(10) Pub. No.: US 2026/0266684 A1
(43) Pub. Date: Sep. 10, 2026

(54) CONTINUOUS TESTING DEVICE FOR IMPACT TESTING OF SPORTS EQUIPMENT

(71) Applicant: Shandong Normal University, Jinan (CN)

(72) Inventor: Bin Zhuang, Jinan (CN)

(21) Appl. No.: 19/176,757

(22) Filed: Apr. 11, 2025

(30) Foreign Application Priority Data
Mar. 5, 2025 (CN) 2025102573909

(51) Int. Cl. G01M 7/08

(52) U.S. Cl. CPC G01M 7/08

(57) ABSTRACT

A continuous testing device for impact testing of sports equipment is provided, relates to the field of sports equipment testing and includes a test bench. A transmission mechanism is disposed on the test bench. A front end of the transmission mechanism is fixedly connected to five impact tanks. An upper part of each of the five impact tanks is provided with two limiting mechanisms, and the two limiting mechanisms are disposed opposite to each other. The limiting mechanisms are configured to limit an upper end of a racket-type sports equipment, thereby effectively ensuring that the racket-type sports equipment will not bounce off the impact tank after being impacted. An adjusting mechanism is disposed in each of the five impact tanks, and the adjusting mechanism is configured to flexibly adjust a space area in the impact tank according to a size of the racket-type sports equipment.

### TECHNICAL FIELD

The disclosure relates to the technical field of testing of sports equipment, and more particularly to a continuous testing device for impact testing of sports equipment.

### BACKGROUND

A background technology of a continuous testing device for impact testing of sports equipment mostly stems from a high requirement for a quality and performance of sports equipment. With a popularization of sports and a diversification of sports events, types and specifications of sports equipment are increasing, and their quality and performance directly affect user's safety as well as usage effects. Therefore, during a production process, a material performance of sports equipment must be strictly tested, and an impact testing is an essential part. Related impact testing devices often suffer from low testing efficiency and complex operations, failing to meet needs of large-scale and high-efficiency testing. In order to solve these problems, a continuous testing device for impact testing of sports equipment came into being. Through continuous and automatic testing process, the continuous testing device for impact testing of sports equipment greatly improved a testing efficiency and ensured the quality and performance of sports equipment.

Based on search, a patent with Chinese Patent No. CN115597814B discloses a continuous testing device for impact testing of sports equipment. The continuous testing device for impact testing of sports equipment includes an impact unit and a delivery unit; the impact unit includes a motor, a housing and an impact component; the motor is disposed at a side of the housing, and the impact component is disposed at another side of the housing. The delivery unit includes a transmission rack and a support disk. With the transmission rack being semi-meshed with the impact unit, the disclosure enables an impact test process and a delivery process to be coordinated during use, making testing continuous and improving a work efficiency. Compared with the related art, the patent with Chinese Patent No. CN115597814B aims to solve the problem that a continuous testing device for impact testing of sports equipment in related art usually tests one item at a time and then places another item for testing after the testing is completed, which cannot conduct large-scale testing and leads to waste of time and resources.

However, during an actual use of the aforementioned device, racket-type sports equipment lacks positioning when undergoing impact testing in an impact tank. The sports equipment being impacted is prone to bounce upwards under an impact, causing the sports equipment to break away from the impact tank and affecting a continuity of the impact testing. Therefore, a continuous testing device for impact testing of sports equipment is proposed.

### SUMMARY

The disclosure provides a continuous testing device for impact testing of sports equipment to solve a deficiency that racket-type sports equipment lacks positioning when undergoing impact tests in an impact tank and is prone to bounce upwards under an impact, causing the racket-type sports equipment to break away from the impact tank and affecting a continuity of the impact tests.

To achieve aforementioned objectives, technical solutions adopted by the disclosure are as follows.

The continuous testing device for impact testing of sports equipment, includes a test bench; a transmission mechanism is disposed on the test bench, a front end of the transmission mechanism is fixedly connected to impact tanks, the impact tanks are five in number; an upper part of each of the five impact tanks is provided with two limiting mechanisms, the two limiting mechanisms are disposed opposite to each other; each of the two limit mechanisms includes a limit housing, the limiting housing is fixedly connected to the upper part of the impact tank; a third motor is disposed at a side of the limit housing; a worm is disposed on an output end of the third motor; a sixth gear is fixedly connected to a side of the worm facing away from the third motor and is rotatably connected to the limit housing; a second rack is meshed with the sixth gear and slidably connected to the limit housing, and a pressure plate is fixedly connected to an upper part of the second rack.

A worm wheel is meshed with the worm and rotatably connected to the limit housing; a seventh gear is connected to a side of the worm wheel facing away from the limit housing; and a first rack is meshed with the seventh gear, and the first rack is slidably connected to the limit housing and the first rack is fixedly connected to the impact tank. The racket-type sports equipment is configured for being placed in one of the five impact tanks, the third motor is configured to be started to drive the worm and the sixth gear to rotate; the worm is configured to: under rotation of the worm, drive the seventh gear to move along an extending direction of the first rack meshed with the seventh gear, to thereby drive the limiting housing to move to limit the equipment. The sixth gear is configured to rotate in synchronization with movement of the limiting housing, and thereby drive the pressure plate to move downwards, thereby pressing the racket-type sports equipment downward; and sliding slots for the first rack and the second rack to slide are provided inside the limiting housing.

The aforementioned technical solution further includes an adjusting mechanism.

The adjusting mechanism is disposed in each of the five impact tanks, and the adjusting mechanism is configured to drive two adjusting plates disposed at two sides of the adjusting mechanism to move inward, so as to adjust a space area in the impact tank.

The adjusting mechanism includes an adjusting housing, and the adjusting housing is fixedly connected to an inner side of the impact tank; a fourth motor is disposed on a side of the adjusting housing, and an adjusting assembly is disposed on an output end of the fourth motor.

The adjusting assembly includes a rotating rod, the rotating rod is disposed on the output end of the fourth motor, two sides of the rotating rod are respectively rotatably connected to two connecting rods, and the two connecting rods are symmetrically disposed on two sides of the rotating rod; and a side of each of the connecting rods facing away from the rotating rod is rotatably connected to a corresponding one of the two adjusting plates, and the two adjusting plates are slidably connected to the adjusting housing.

The transmission mechanism includes a transmission housing, and the transmission housing is fixedly connected onto the test bench, a second motor is provided in the transmission housing, and a transmission assembly is disposed on an output end of the second motor.

A screw rod is disposed on the output end of the second motor, and the screw rod is rotatably connected to the transmission housing and threadedly connected to the five impact tanks.

A control housing is fixedly connected onto the test bench, and an impact housing is fixedly connected to a front end of the control housing.

A first motor is disposed in the control housing, a fourth gear is disposed on an output end of the first motor, a fifth gear is meshed with the fourth gear and rotatably connected to the control housing, and a first gear is fixedly connected to a side of the fifth gear facing away from the control housing.

Two second gears are symmetrically meshed with two sides of the first gear and rotatably connected to the impact housing; and sides the two second gears facing away from the impact housing is fixedly connected to third gears; the third gears are meshed with an impact rod; a limit tank is slidably connected to a lower part of the impact rod and fixedly connected to the impact housing, an impact head is fixedly connected to a bottom part of the impact rod, and the third gears are half-gears, i.e., non-integral gears.

The disclosure has at least two beneficial effects as follows.

Beneficial effect 1: in the disclosure, when the racket-type sports equipment is placed in one of the five impact tanks, the adjusting mechanism can be started to drive the two adjusting plates disposed on two sides of the connecting rods to move inward, so as to flexibly adjust an area of the impact tank according to a size of the racket-type sports equipment; after the racket-type sports equipment has been placed in the impact tank, the third motor can be started to drive the worm and the sixth gear to rotate synchronously; the worm can drive, under rotation of the worm, the seventh gear to move along an extending direction of the first rack meshed with the seventh gear, thereby drive the limiting housing to move to limit the equipment; and the sixth gear can rotate in synchronization with movement of the limiting housing, thereby drive the pressure plate to move downwards, so as to limit an upper end of the racket-type sports equipment, thereby effectively ensuring that the racket-type sports equipment will not bounce off the impact tank after being impacted.

Beneficial effect 2: in the disclosure, after the racket-type sports equipment has been fixed, the first motor can be started to drive the first gear to rotate; the first gear can drive, under rotation of the first gear, the third gears disposed on both sides of the first gear to rotate in a same direction. Further, since the third gears are half-gears, the third gears disposed on both sides of the first gear can drive, under rotations of the third gears, the impact rod meshed with the third gears to move up and down reciprocally, thereby drive the impact head to continuously impact the racket-type sports equipment.

### BRIEF DESCRIPTION OF DRAWINGS

FIG. 1 illustrates a schematic structural diagram of a continuous testing device for impact testing of sports equipment according to the disclosure.

FIG. 2 illustrates a schematic internal structural diagram of an impact housing of the continuous testing device for impact testing of sports equipment according to the disclosure.

FIG. 3 illustrates a schematic internal structural diagram of a control housing of the continuous testing device for impact testing of sports equipment according to the disclosure.

FIG. 4 illustrates a schematic internal structural diagram of a transmission housing of the continuous testing device for impact testing of sports equipment according to the disclosure.

FIG. 5 illustrates a schematic internal structural diagram of an impact tank of the continuous testing device for impact testing of sports equipment according to the disclosure.

FIG. 6 illustrates a schematic internal structural diagram of a limit housing of the continuous testing device for impact testing of sports equipment according to the disclosure.

FIG. 7 illustrates a rear view of an adjustment mechanism of the continuous testing device for impact testing of sports equipment according to the disclosure.

FIG. 8 illustrates a front view of the adjustment mechanism of the continuous testing device for impact testing of sports equipment according to the disclosure.

### DESCRIPTION OF REFERENCE NUMERALS

1: test bench; 2: impact housing; 3: impact head; 4: transmission housing; 5: impact tank; 6: adjusting plate; 7: control housing; 8: first gear; 9: second gear; 10: connecting rod; 11: third gear; 12: impact rod; 13: limit tank; 14: first motor; 15: fourth gear; 16: fifth gear; 17: second motor; 18: screw rod; 19: limit housing; 20: adjusting housing; 21: third motor; 22: worm; 23: sixth gear; 24: pressure plate; 25: first rack; 26: second rack; 27: worm wheel; 28:seventh gear; 29: fourth motor; 30: rotating rod.

### DETAILED DESCRIPTION OF EMBODIMENTS

The technical solutions in embodiments of the disclosure will be clearly and completely described below with reference to the attached drawings in the embodiments of the disclosure. Apparently, the described embodiments are merely part of the embodiments of the disclosure, not all of them. Based on the embodiments of the disclosure, all other embodiments obtained by those skilled in the art without making creative labors fall within the scope of protection of the disclosure.

### Embodiment 1

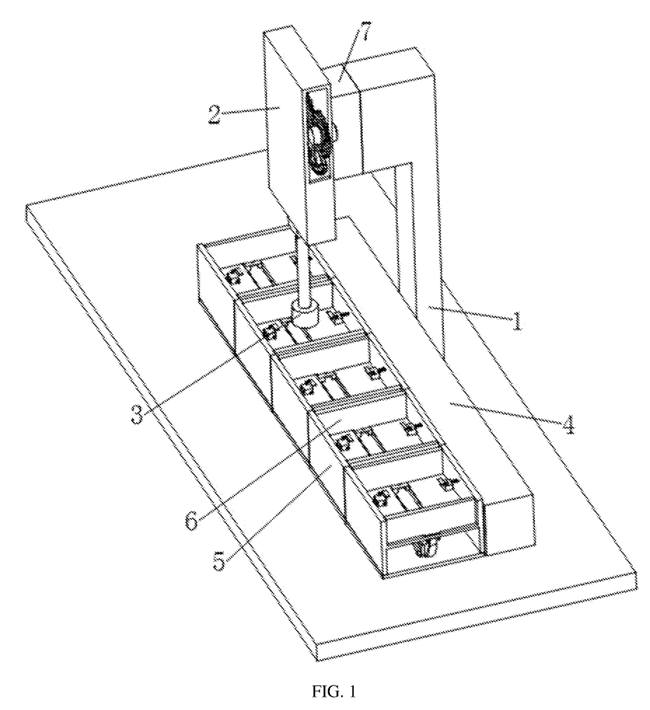

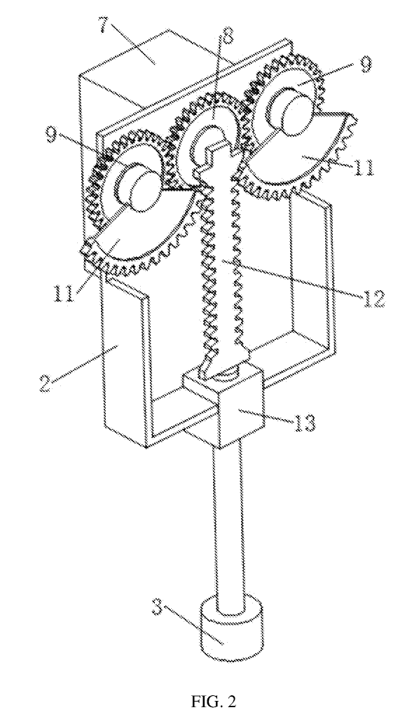

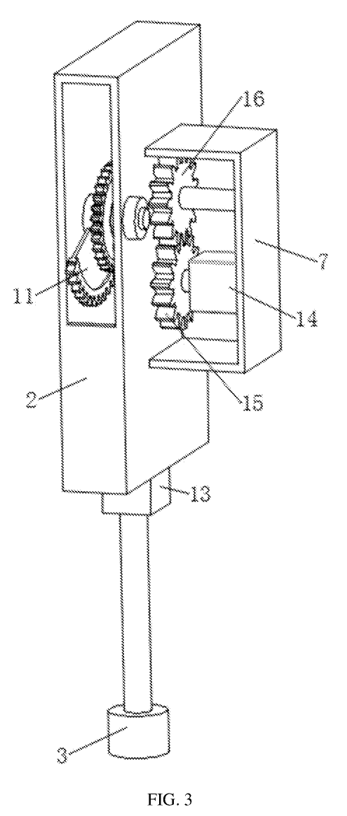

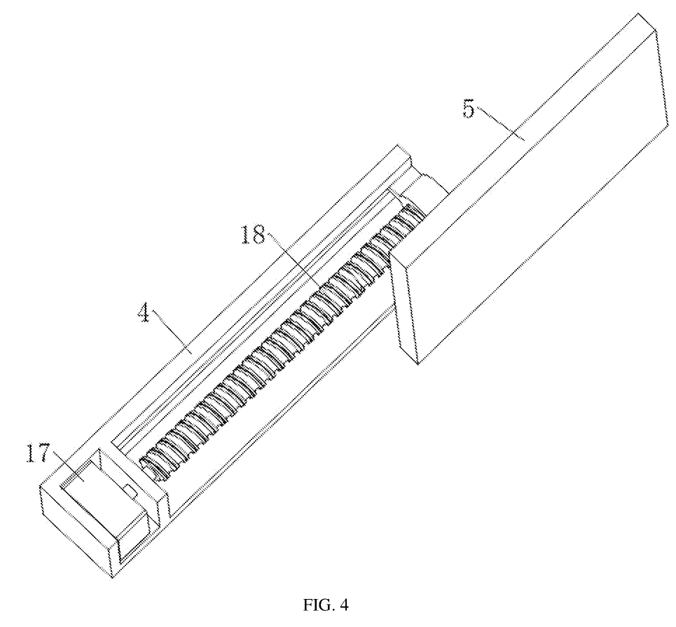

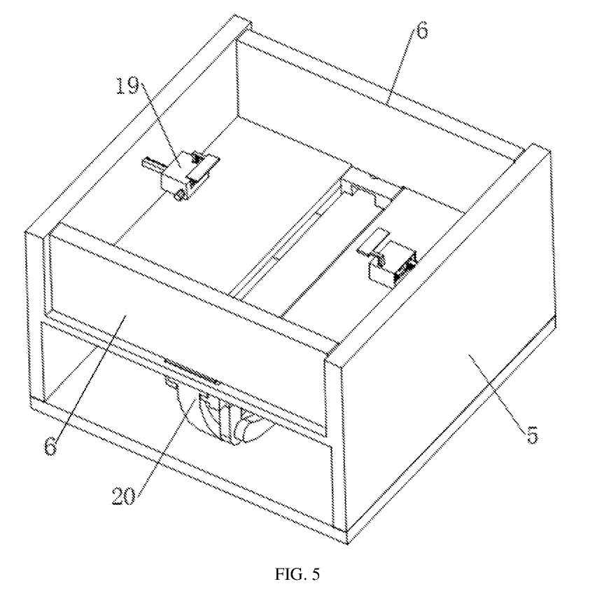

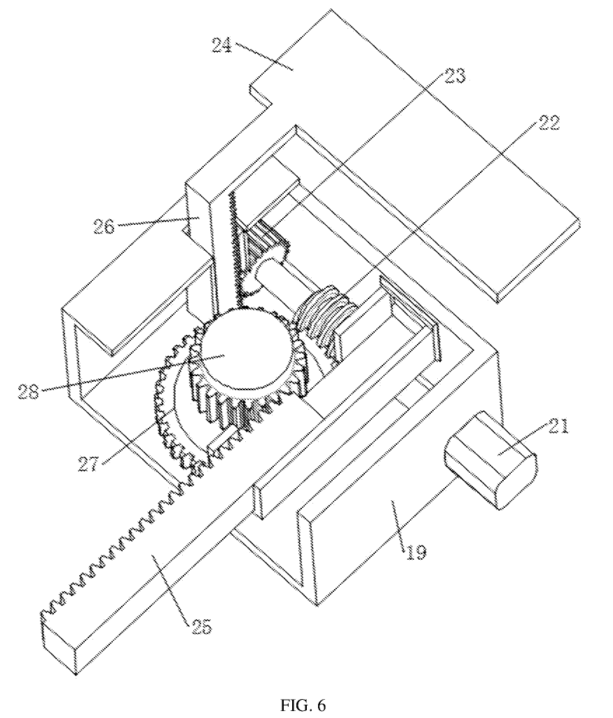

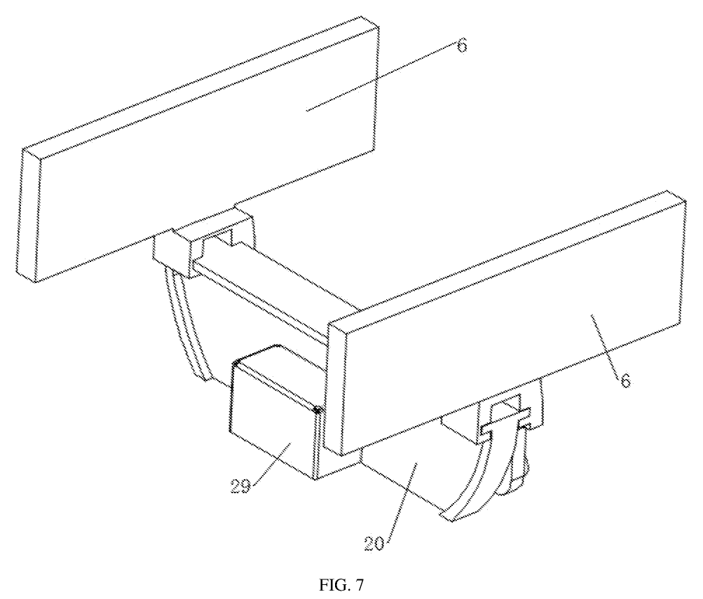

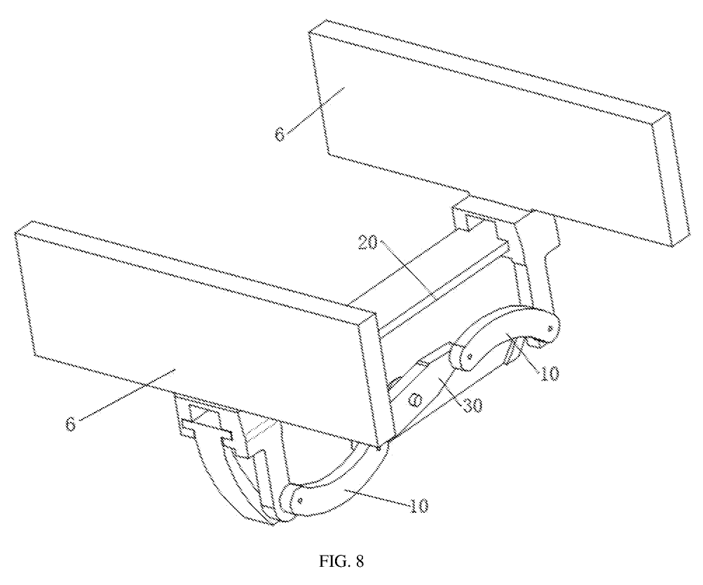

As illustrated in FIG. 1-FIG. 8, a continuous testing device for impact testing of sports equipment includes a test bench 1. A transmission mechanism is disposed on the test bench 1. A front end of the transmission mechanism is fixedly connected to impact tanks 5, and the impact tanks are five in number. An upper part of each of the five impact tanks 5 is provided with two limiting mechanisms, and the two limiting mechanisms are disposed opposite to each other. Each of the two limit mechanisms includes a limit housing 19, and the limit housing 19 is fixedly connected to the upper part of the impact tank 5. A third motor 21 is disposed at a side of the limit housing 19. A worm 22 is disposed on an output end of the third motor 21. A sixth gear 23 is fixedly connected to a side of the worm 22 facing away from the third motor 21 and is rotatably connected to the limit housing 19. A second rack 26 is meshed with the sixth gear 23 and slidably connected to the limit housing 19. A pressure plate 24 is fixedly connected to an upper part of the second rack 26.

A worm wheel 27 is meshed with the worm 22 and rotatably connected to the limit housing 19. A seventh gear 28 is connected to a side of the worm wheel 27 facing away from the limit housing 19. A first rack 25 is meshed with the seventh gear 28, the first rack 25 is slidably connected to the limit housing 19, and the first rack 25 is fixedly connected to the impact tank 5. When the racket-type sports equipment is placed in one of the five impact tanks 5, the third motor 21 is configured to be started to drive the worm 22 and the sixth gear 23 to rotate. The worm 22 is configured to: under rotation of the worm 22, drive the worm wheel 27 to rotate. The worm wheel 27 is configured to: under rotation of the worm wheel 27, drive the seventh gear 28 fixedly connected to the worm wheel 27 to rotate. The seventh gear 28 is configured to: under rotation of the seventh gear 28, drive the seventh gear 28 to move along an extending direction of the first rack 25 meshed with the seventh gear 28, to thereby drive the limiting housing 19 to move to limit the equipment. The sixth gear 23 is configured to rotate in synchronization with the limiting housing 19 and thereby drive the second rack 26 meshed with the sixth gear 23 to move downwards. The second rack 26 is configured to: under movement of the second rack 26, drive the pressure plate 24 fixedly connected to the second rack 26 to move downwards, so as to limit an upper end of the sports equipment, thereby effectively ensuring that the racket-type sports equipment will not bounce off a corresponding one of the five impact tanks 5 after being impacted. Sliding slots for the first rack 25 and the second rack 26 to slide are provided inside the limiting housing 19.

An adjusting mechanism is disposed in each of the five impact tanks 5. The adjusting mechanism is configured to drive two adjusting plates 6 disposed at two sides of the adjusting mechanism to move inward, so as to adjust a space area in the impact tank 5. The adjusting mechanism includes an adjusting housing 20, and the adjusting housing 20 is fixedly connected to an inner side of the impact tank 5. A fourth motor 29 is disposed on a side of the adjusting housing 20. An adjusting assembly is disposed on an output end of the fourth motor 29. The adjusting assembly includes a rotating rod 30, and the rotating rod 30 is disposed on the output end of the fourth motor 29. Two sides of the rotating rod 30 are respectively rotatably connected to two connecting rods 10, and the two connecting rods 10 are symmetrically disposed on two sides of the rotating rod 30. A side of each of the connecting rods 10 facing away from the rotating rod 30 is rotatably connected to a corresponding one of the two adjusting plates 6, and the two adjusting plates 6 are slidably connected to the adjusting housing 20.

In this embodiment, when the racket-type sports equipment is placed in one of the five impact tanks 5, the fourth motor 29 can be started to drive the rotating rod 30 to rotate. The rotating rod 30 can drive, under rotation of the rotating rod 30, the two connecting rods 10 rotatably connected to the two sides of the rotating rod 30 to rotate. The two connecting rods 10 can drive, under rotations of the connecting rods 10, the adjusting plates 6 rotatably connected to the connecting rods 10 to move. By driving the adjusting plates 6 disposed on two sides of the connecting rods 10 to move inward, the testing device can flexibly adjust an area of the impact tank 5 according to a size of the racket-type sports equipment. After the racket-type sports equipment has been placed in the impact tank 5, the third motor 21 can be started to drive the worm 22 and the sixth gear 23 to rotate synchronously. The worm 22 can drive, under rotation of the worm 22, the worm wheel 27 to rotate. The worm wheel 27 can drive, under rotation of the worm wheel 27, the seventh gear 28 fixedly connected to the worm wheel 27 to rotate to move along an extending direction of the first rack 25 meshed with the seventh gear 28, thereby drive the limiting housing 19 to move to limit the equipment. The sixth gear 23 can rotate in synchronization with movement of the limiting housing 19 and thereby drive the second rack 26 meshed with the six gear 23 to move downwards. The second rack 26 can drive, under movement of the second rack 26, the pressure plate 24 fixedly connected to the second rack 26 to move downwards, so as to limit an upper end of the equipment, thereby effectively ensuring that the racket-type sports equipment will not bounce off the impact tank 5 after being impacted.

### Embodiment 2

As illustrated in FIG. 1-FIG. 8, the transmission mechanism includes a transmission housing 4, the transmission housing 4 is fixedly connected onto the test bench 1. A second motor 17 is provided in the transmission housing 4. A transmission assembly is disposed on an output end of the second motor 17. A screw rod 18 is disposed on the output end of the second motor 17, and the screw rod is rotatably connected to the transmission housing 4 and threadedly connected to the five impact tanks 5.

A control housing 7 is fixedly connected onto the test bench 1. An impact housing 2 is fixedly connected to a front end of the control housing 7. A first motor 14 is disposed in the control housing 7. A fourth gear 15 is disposed on an output end of the first motor 14. A fifth gear 16 is meshed with the fourth gear 15 and rotatably connected to the control housing 7. A first gear 8 is fixedly connected to a side of the fifth gear 16 facing away from the control housing 7. Two second gears 9 are symmetrically meshed with two sides of the first gear 8 and rotatably connected to the impact housing 2. Sides of the second gears 9 facing away from the impact housing 2 are fixedly connected to third gears 11. The third gears 11 are meshed with an impact rod 12. A limit tank 13 is slidably connected to a lower part of the impact rod 12 and fixedly connected to the impact housing 2. An impact head 3 is fixedly connected to a bottom part of the impact rod 12. The third gears 11 are half-gears.

In this embodiment, when the racket-type sports equipment is placed in one of the five impact tanks, the first motor 14 can be started to drive the fourth gear 15 to rotate. The fourth gear 15 can drive, under rotation of the fourth gear 15, the fifth gear 16 meshed with the fourth gear 15 to rotate. The fifth gear 16 can drive, under rotation of the fifth gar 16, the first gear 8 fixedly connected to the fifth gear 16 to rotate. The first gear 8 can drive, under rotation of the first gear 8, the two second gears 9 meshed with two sides of the first gear 8 to rotate. The two second gears 9 can drive, under rotations of the second gears 9, the third gears 11 fixedly connected to the second gears 9 to rotate in a same direction. Further, since the third gears 11 are half gears, the third gears 11 disposed on both sides of the impact rod 12 can drive, under the rotations of the third gears 11, the impact rod 12 meshed with the third gears 11 to move up and down reciprocally, thereby drive the impact head 3 to continuously impact the racket-type sports equipment. When the impact head 3 conducts continuous impacts, the second motor 17 can be started to drive the screw rod 18 to rotate. The screw rod 18 can drive, under rotation of the screw rod 18, the five impact tanks 5 threadedly connected to the screw rod 18 to move. A movement of the impact tank 5 and continuous impacts of the impact head 3 can be coordinated to conduct a continuous testing.

Although the embodiments of the disclosure have been shown and described, those skilled in the art should understand that various changes, modifications, substitutions, and alterations can be made to these embodiments without departing from the principle and spirit of the disclosure. A scope of protection of the disclosure is defined by attached claims of the specification and their equivalents.

What is claimed is:

1. A continuous testing device for impact testing of sports equipment, the continuous testing device comprising a test bench (1), wherein impact tanks (5) are disposed on the test bench (1), an upper part of each of the impact tanks (5) is provided with two limiting mechanisms, the two limiting mechanisms are disposed opposite to each other, each of the two limit mechanisms comprises a limit housing (19), the limit housing (19) is fixedly connected to the upper part of the impact tank (5), a third motor (21) is disposed on a side of the limit housing (19), a worm (22) is disposed on an output end of the third motor (21), a sixth gear (23) is fixedly connected to a side of the worm (22) facing away from the third motor (21) and is rotatably connected to the limit housing (19), a second rack (26) is meshed with the sixth gear (23) and slidably connected to the limit housing (19), and a pressure plate (24) is fixedly connected to an upper part of the second rack (26);
wherein a worm wheel (27) is meshed with the worm (22) and rotatably connected to the limit housing (19); a seventh gear (28) is connected to a side of the worm wheel (27) facing away from the limit housing (19); and a first rack (25) is meshed with the seventh gear (28), the first rack (25) is slidably connected to the limit housing (19), and the first rack (25) is fixedly connected to the impact tank (5); and
wherein the sports equipment is configured for being placed in the impact tank (5), the third motor (21) is configured to be started to drive the worm (22) and the sixth gear (23) to rotate; the worm (22) is configured to: under rotation of the worm (22), drive the seventh gear (28) to move along an extending direction of the first rack (25), to thereby drive the limiting housing (19) to move to limit the sports equipment; and the sixth gear (23) is configured to rotate in synchronization with movement of the limiting housing (19), and thereby drive the pressure plate (24) to move downwards, thereby pressing the sports equipment downward.

2. The continuous testing device for impact testing of sports equipment as claimed in claim 1, wherein a transmission mechanism is disposed on the test bench (1); the impact tanks (5) are five in number, and the five impact tanks (5) are fixedly connected to a front end of the transmission mechanism; an adjusting mechanism is disposed in each of the five impact tanks (5), the adjusting mechanism is configured to drive two adjusting plates (6) disposed at two sides of the adjusting mechanism to move inward, the adjusting mechanism comprises an adjusting housing (20), and the adjusting housing(20) is fixedly connected to an inner side of the impact tank (5); a fourth motor (29) is disposed on a side of the adjusting housing (20); an adjusting assembly is disposed on an output end of the fourth motor (29); the adjusting assembly comprises a rotating rod (30), the rotating rod (30) is disposed on the output end of the fourth motor (29); two sides of the rotating rod (30) are respectively rotatably connected to two connecting rods (10), and the two connecting rods (10) are symmetrically disposed on the two sides of the rotating rod (30); and a side of each of the two connecting rods (10) facing away from the rotating rod (30) is rotatably connected to a corresponding one of the two adjusting plates (6), and the two adjusting plates (6) are slidably connected to the adjusting housing (20).

3. The continuous testing device for impact testing of sports equipment as claimed in claim 2, wherein the transmission mechanism comprises a transmission housing (4), and the transmission housing (4) is fixedly connected onto the test bench (1); a second motor (17) is provided in the transmission housing (4); and a transmission assembly is disposed on an output end of the second motor (17).

4. The continuous testing device for impact testing of sports equipment as claimed in claim 1, wherein a control housing (7) is fixedly connected onto the test bench (1); an impact housing (2) is fixedly connected to a front end of the control housing (7); a first motor (14) is disposed in the control housing (7); a fourth gear (15) is disposed on an output end of the first motor (14); a fifth gear (16) is meshed with the fourth gear (15) and rotatably connected to the control housing (7); a first gear (8) is fixedly connected to a side of the fifth gear (16) facing away from the control housing (7); two second gears (9) are symmetrically meshed with two sides of the first gear (8) and rotatably connected to the impact housing (2), and sides of the second gears (9) facing away from the impact housing (2) are fixedly connected to third gears (11); the third gears (11) are meshed with an impact rod (12); a limit tank (13) is slidably connected to a lower part of the impact rod (12) and fixedly connected to the impact housing (2); and an impact head (3) is fixedly connected to a bottom part of the impact rod (12).
